(19) United States
(12) Patent Application Publication
(10) Pub. No.: US 2026/0066347 A1
(43) Pub. Date: Mar. 5, 2026

(54) ELECTROCHEMICAL APPARATUS AND ELECTRONIC DEVICE

(71) Applicant: Ningde Amperex Technology Limited, Ningde (CN)

(72) Inventors: Qi JIANG, Ningde (CN); Jianyu LIU, Ningde (CN); Chao TANG, Ningde (CN); Junhui YANG, Ningde (CN)

(73) Assignee: Ningde Amperex Technology Limited, Ningde (CN)

(21) Appl. No.: 19/313,891

(22) Filed: Aug. 29, 2025

(30) Foreign Application Priority Data
Aug. 30, 2024 (CN) 202411208223.7

(51) Int. Cl. H01M 10/0567; H01M 4/02; H01M 4/133; H01M 4/134; H01M 4/36; H01M 4/38; H01M 4/587; H01M 4/62; H01M 10/0525; H01M 10/0568; H01M 10/0569

(52) U.S. Cl. CPC H01M 10/0567; H01M 4/133; H01M 4/134; H01M 4/364; H01M 4/366; H01M 4/386; H01M 4/587; H01M 4/62; H01M 10/0525; H01M 10/0568; H01M 10/0569; H01M 2004/021; H01M 2004/027; H01M 2300/0037; H01M 2300/0042

(57) ABSTRACT

An electrochemical apparatus includes a negative electrode plate and an electrolyte. The negative electrode plate includes a negative electrode material layer, the negative electrode material layer contains silicon-carbon particles, and a surface of the silicon-carbon particles has a surface layer, where a thickness of the surface layer is X μm. The electrolyte includes a compound represented by formula I, and based on a mass of the electrolyte, a mass percentage of the compound represented by formula I is a %, 0.5≤a≤20, and 1<X/a<10.

### CROSS REFERENCE TO THE RELATED APPLICATION

This application claims the benefit of priority from the Chinese Patent Application No. 202411208223.7, filed on Aug. 30, 2024, the entire content of which is incorporated herein by reference.

### TECHNICAL FIELD

This application relates to the field of electrochemical technologies, and particularly to an electrochemical apparatus and an electronic device.

### BACKGROUND

Lithium-ion batteries, are widely used in portable electronic devices such as mobile phones, laptops, and cameras because of advantages such as high energy density, high operating voltage, long cycle life, and environmental friendliness, and are also the preferred power source for future electric vehicles and hybrid vehicles. Currently, to increase the energy density of lithium-ion batteries, an electrode material with a high specific capacity is mainly used or a high voltage is provided. Silicon-based materials, as a type of alloying negative electrode material, can provide an ultra-high specific capacity of up to 4200 mAh/g. However, silicon negative electrodes experience severe volume expansion/contraction during lithium-ion intercalation/deintercalation process. Additionally, achieving the required energy density with high voltage during the application process can also lead to volume expansion and impedance increase of a battery as temperature rises.

### SUMMARY

In view of this, this application provides an electrochemical apparatus and an electronic device. By cooperatively regulating a thickness of a surface layer of silicon-carbon particles to be within a suitable range and an electrolyte including a compound represented by formula I with a content thereof also within a suitable range, the high-temperature and high-voltage performance of a silicon negative electrode lithium-ion battery can be improved.

According to a first aspect, this application provides an electrochemical apparatus and an electronic device, and the electrochemical apparatus includes a negative electrode plate and an electrolyte. The negative electrode plate includes a negative electrode material layer, the negative electrode material layer contains silicon-carbon particles, and a surface of the silicon-carbon particles has a surface layer, where a thickness of the surface layer is X μm. The surface layer is formed on the silicon negative electrode lithium-ion battery during cyclic charging and discharging, primarily through chemical reactions of components of the electrolyte. The electrolyte includes a compound represented by formula I:

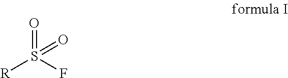

where R is selected from a fluorine-substituted or unsubstituted C₂-C₆ alkyl, a fluorine-substituted or unsubstituted C₆-C₁₂ nitrogen-containing heterocyclic group, or a fluorine-substituted or unsubstituted C₆-C₁₂ aryl group. Based on a mass of the electrolyte, a mass percentage of the compound represented by formula I is a %, 0.5≤a≤20, and 1<X/a<10. This application, by regulating the electrolyte to include the compound represented by formula I and a type and content of the compound represented by formula I to be within the above ranges, while cooperatively regulating the thickness of the surface layer of the silicon-carbon particles to be suitable, can improve the high-temperature and high-voltage performance of the electrochemical apparatus, particularly by reducing volume expansion under conditions of 80° C. and 4.53 V and suppressing impedance increase during cycling at 45° C. at 4.53 V, thereby enhancing a capacity retention rate of the electrochemical apparatus after 500 cycles at 45° C. at 4.53 V. The inventors have found that the presence of the electrolyte including the compound represented by formula I with a suitable type and the content of the compound represented by formula I in the electrolyte can promote the formation of a dense and stable surface layer on the surface of the silicon-carbon particles during the formation and cycling of the silicon negative electrode lithium-ion battery. Further cooperatively regulating a ratio of the thickness of the surface layer to the content of the compound represented by formula I to be within the above range facilitates the protection of a negative electrode active material, reducing the volume expansion and impedance increase caused by the reduction and decomposition of the electrolyte on a surface of the negative electrode active material.

In some embodiments, the compound represented by formula I includes at least one of the following compounds:

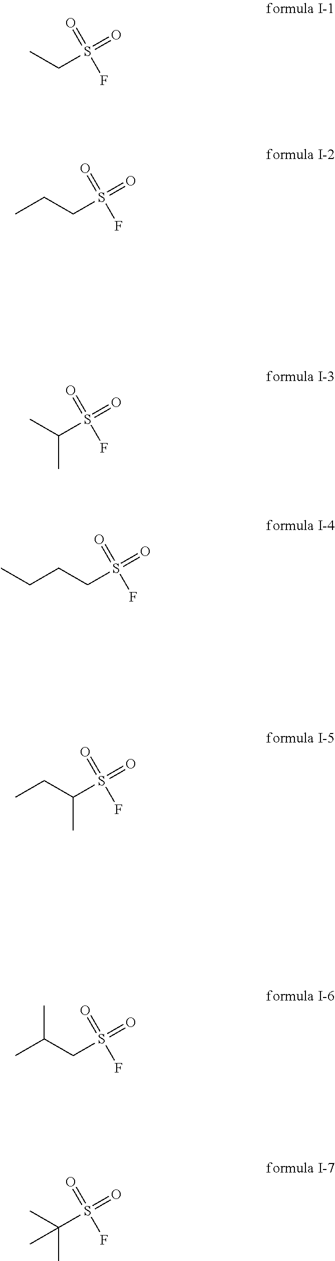

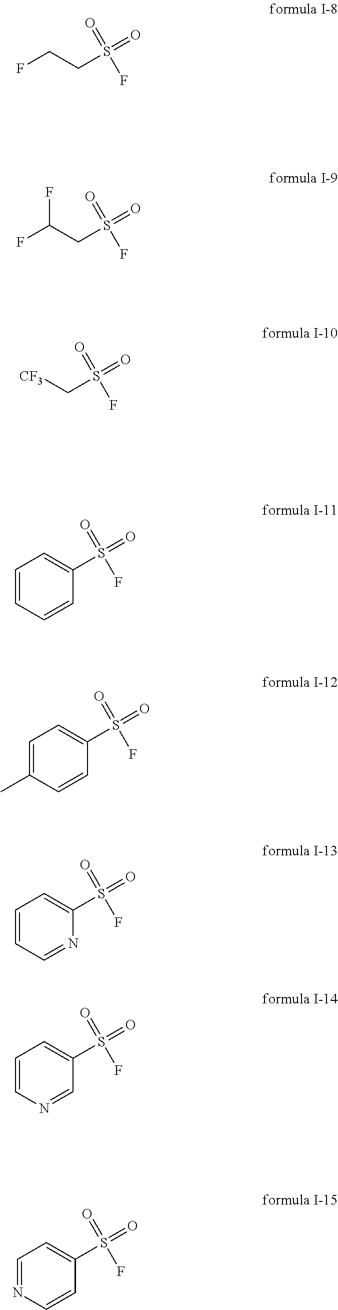

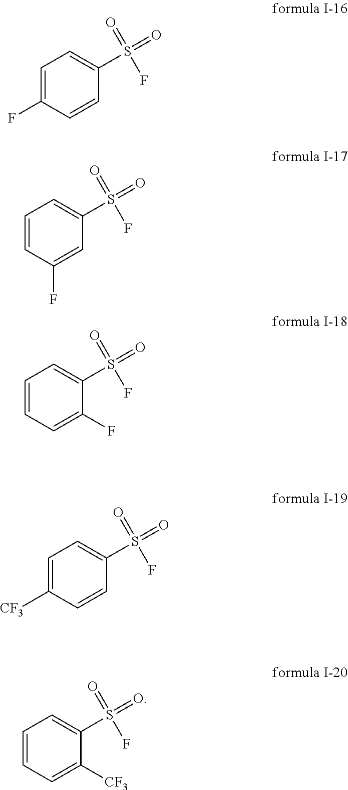 [SMILES: O=S(=O)(F)c1ccc(F)cc1 ; O=S(=O)(F)c1cccc(F)c1 ; O=S(=O)(F)c1ccccc1F ; O=S(=O)(F)c1ccc(C(F)(F)F)cc1 ; O=S(=O)(F)c1ccccc1C(F)(F)F]

The above types of the compound represented by formula I have a better effect in promoting the formation of a dense and stable surface layer on the surface of the silicon-carbon particles during the formation and cycling of the silicon negative electrode lithium-ion battery, which is more conducive to protecting the negative electrode active material and achieving a better effect in improving the high-temperature and high-voltage performance of the silicon negative electrode lithium-ion battery.

In some embodiments, the electrochemical apparatus satisfies at least one of the following conditions: (1) 2≤a≤10, or (2) 5<X<12. Regulating the content a of the compound represented by formula I and the thickness X of the surface layer to be within the above ranges can further reduce volume expansion and suppress impedance increase of the electrochemical apparatus under high-temperature and high-voltage conditions.

In some embodiments, an average particle size of the silicon-carbon particles is Y μm, 0.1≤Y<1, 18<X/Y<22, and 0.04≤Y/a≤0.15. Regulating a ratio of the thickness X of the surface layer to the average particle size Y of the silicon-carbon particles and a ratio of the average particle size Y of the silicon-carbon particles to the content a of the compound represented by formula I to be suitable facilitates further improving volume expansion and suppressing impedance increase of the silicon negative electrode lithium-ion battery under high-temperature and high-voltage conditions, with a better effect in enhancing the high-temperature cycle performance of the silicon negative electrode lithium-ion battery.

In some embodiments, the silicon-carbon particles include a carbon skeleton, amorphous silicon dispersed in the carbon skeleton, and a protective layer located on at least a portion of a surface of the carbon skeleton, where a material of the protective layer includes amorphous carbon, and a material of the carbon skeleton includes at least one of artificial graphite, natural graphite, meso-carbon microbeads, soft carbon, or hard carbon. This facilitates exerting the high energy density of silicon.

In some embodiments, the electrolyte includes fluoroethylene carbonate, and based on the mass of the electrolyte, a mass percentage of the fluoroethylene carbonate is b %, and 12≤b≤22. By further adding fluoroethylene carbonate in the electrolyte and a content of fluoroethylene carbonate within the above range of this application, it facilitates the cooperation with the compound represented by formula I, further improving the high-temperature cycle performance of the silicon negative electrode lithium-ion battery, particularly enhancing a capacity retention rate thereof after 500 cycles at 45° C. at 4.53 V.

In some embodiments, the electrolyte includes a substance A. The substance A includes at least two of diethyl carbonate, propyl propionate, or ethyl propionate, and at least contains diethyl carbonate, and based on the mass of the electrolyte, a mass percentage of the substance A is c %, where 10≤c≤30. Regulating the electrolyte to further contain the substance A and the type and content of the substance A both being suitable improve an effect of the high-temperature cycle performance of the silicon negative electrode lithium-ion battery.

In some embodiments, the electrolyte further includes a substance B. The substance B includes ethylene carbonate and/or propylene carbonate, and based on the mass of the electrolyte, a mass percentage of the substance B is d %, where 10≤d≤20. Regulating the electrolyte to further contain the substance B and the type and content of the substance B both within the ranges of this application can effectively reduce side reactions of a battery during high-temperature cycling and reduce consumption of the electrolyte, further enhancing the high-temperature cycle performance of the silicon negative electrode lithium-ion battery.

In some embodiments, 0.5≤c/d≤3. At this time, an effect of improving the high-temperature cycle performance of the electrochemical apparatus is better.

In some embodiments, the electrolyte includes a boron-containing lithium salt and a substance C, where the boron-containing lithium salt includes at least one of lithium tetrafluoroborate, lithium difluoro (oxalato) borate, or lithium bis(oxalato) borate, and the substance C includes vinylene carbonate and/or 1,3-propane sultone. Based on a total mass of the electrolyte, a mass percentage of the boron-containing lithium salt is 0.1% to 5%, and a mass percentage of the substance C is 0.5 wt % to 5 wt %. Regulating the electrolyte to contain the boron-containing lithium salt and the substance C with the above types and contents enables the boron-containing lithium salt, the substance C, and the compound represented by formula I to cooperate, promoting the formation of a suitable surface layer on the surface of the silicon-carbon particles, thereby improving the high-temperature and high-voltage performance of the silicon negative electrode lithium-ion battery.

According to a second aspect, this application provides an electronic device, including the electrochemical apparatus according to any one of the above embodiments. Therefore, the electronic device provided by this application has good high-temperature performance.

The electrochemical apparatus provided by the first aspect of this application exhibits small volume expansion and low impedance increase under high-temperature and high-voltage conditions. Therefore, the electronic device provided by the second aspect of this application also exhibits small volume expansion and low impedance increase under high-temperature and high-voltage conditions.

### DETAILED DESCRIPTION

To make the objectives, technical solutions, and advantages of this application more comprehensible, the following describes this application in detail with reference to the embodiments and accompanying drawings. It should be understood that the specific embodiments described herein are merely used to explain this application but are not intended to limit this application.

It should be noted that in the specific embodiments of this application, a lithium-ion secondary battery is used as an example of an electrochemical apparatus to explain this application, but the electrochemical apparatus in this application is not limited to the lithium-ion secondary battery.

### Lithium-Ion Secondary Battery

A lithium-ion secondary battery includes a negative electrode plate and an electrolyte. The negative electrode plate includes a negative electrode current collector and a negative electrode material layer disposed on at least one surface of the negative electrode current collector. The negative electrode material layer contains silicon-carbon particles, and a surface of the silicon-carbon particles has a surface layer, where a thickness of the surface layer is X μm. The electrolyte includes a compound represented by formula I:

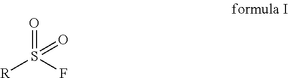

where R is selected from a fluorine-substituted or unsubstituted C₂-C₆ alkyl, a fluorine-substituted or unsubstituted C₆-C₁₂ nitrogen-containing heterocyclic group, or a fluorine-substituted or unsubstituted C₆-C₁₂ aryl group. Based on a mass of the electrolyte, a mass percentage of the compound represented by formula I is a %, 0.5≤a≤20, and 1<X/a<10. Preferably, 2≤a≤10, and 5<X<12. This application, by regulating the electrolyte to include the compound represented by formula I and a type and content of the compound represented by formula I to be within the above ranges, while cooperatively regulating the thickness of the surface layer of the silicon-carbon particles to be within a suitable range, can improve the high-temperature and high-voltage performance of the electrochemical apparatus. For example, the value of a % may be 0.5%, 0.9%, 2%, 2.2%, 3.5%, 5.4%, 7%, 8.7%, 10%, 10.5%, 11.5%, 13.2%, 15.3%, 16.8%, 17.1%, 18.6%, 20%, or falls within a range defined by any two of these values. For example, the value of X may be 5.1, 5.8, 6, 6.4, 7.1, 7.6, 8, 8.4, 8.9, 9.6, 10, 10.5, 11.1, 11.8, or falls within a range defined by any two of these values. For example, the value of X/a may be 1.2, 1.4, 2.2, 2.9, 3, 4.3, 4.6, 5.5, 6.0, 6.9, 7.4, 8.2, 8.9, 9.5, 9.9, or falls within a range defined by any two of these values.

In some embodiments, the compound represented by formula I includes at least one of the following compounds:

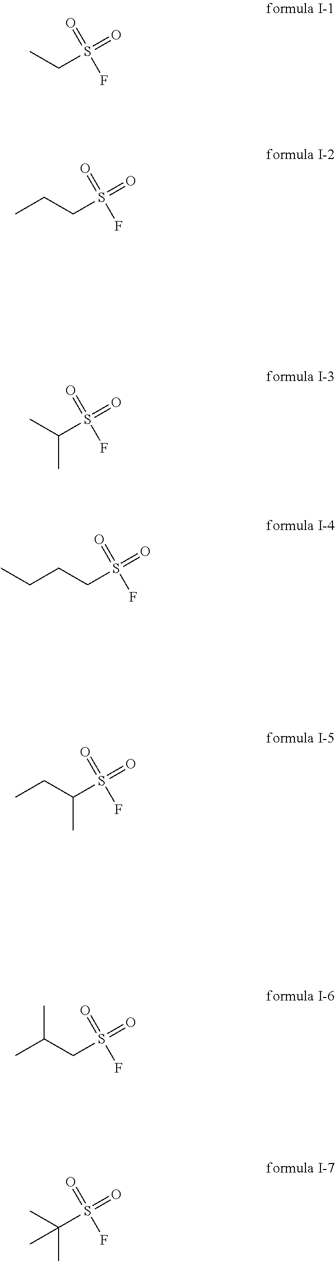

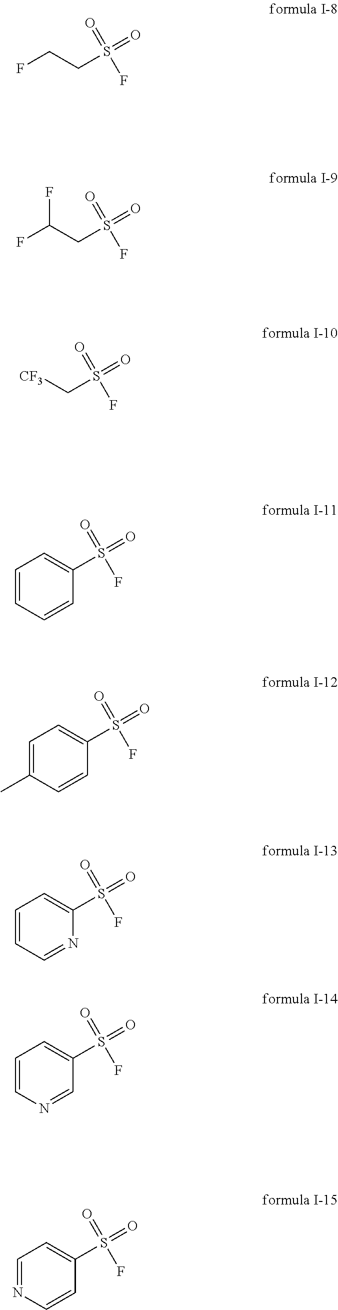

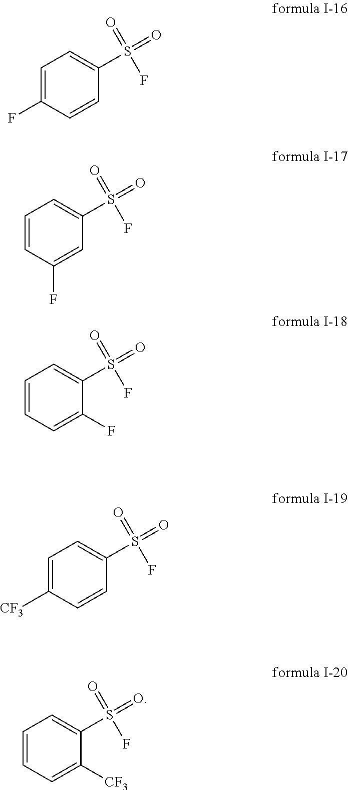 [SMILES: O=S(=O)(F)c1ccc(F)cc1 ; O=S(=O)(F)c1cccc(F)c1 ; O=S(=O)(F)c1ccccc1F ; O=S(=O)(F)c1ccc(C(F)(F)F)cc1 ; O=S(=O)(F)c1ccccc1C(F)(F)F]

In some embodiments, an average particle size of the silicon-carbon particles is Y μm, 0.1≤Y<1, 18<X/Y<22, and 0.04≤Y/a≤0.15. Regulating a ratio of the thickness X of the surface layer to the average particle size Y of the silicon-carbon particles and a ratio of the average particle size Y of the silicon-carbon particles to the content a of the compound represented by formula I to be within suitable ranges facilitates further improving volume expansion and suppressing impedance increase of the silicon negative electrode lithium-ion battery under high-temperature and high-voltage conditions, with a better effect in enhancing cycle performance of the silicon negative electrode lithium-ion battery under high-temperature and high-voltage conditions. For example, the value of Y may be 0.1, 0.17, 0.22, 0.29, 0.36, 0.42, 0.45, 0.58, 0.62, 0.68, 0.75, 0.79, 0.90, 0.99, or falls within a range defined by any two of these values. For example, the value of X/Y can be 18.1, 18.5, 18.8, 19, 19.3, 19.5, 19.8, 20, 20.5, 21, 21.3, 21.5, 21.8, or falls within a range defined by any two of these values. For example, the value of Y/a may be 0.04, 0.05, 0.06, 0.08, 0.1, 0.12, 0.13, 0.15, or falls within a range defined by any two of these values.

In some embodiments, the electrolyte includes fluoroethylene carbonate, and based on a mass of the electrolyte, a mass percentage of the fluoroethylene carbonate is b %, and 12≤b≤22. Adding fluoroethylene carbonate within the above content range to the electrolyte facilitates the cooperation with the compound represented by formula I, further improving the high-temperature cycle performance of the silicon negative electrode lithium-ion battery. For example, the value of b may be 12, 13, 14, 15, 16, 17, 18, 19, 20, 21, 22, or falls within a range defined by any two of these values.

In some embodiments, the electrolyte includes a substance A. The substance A includes at least two of diethyl carbonate, propyl propionate, or ethyl propionate, and at least contains diethyl carbonate, and based on the mass of the electrolyte, the mass percentages of the substance A is c %, where 10≤c≤30. Setting both the type and content of the substance A in the electrolyte to be within the range of this application can further improve the high-temperature cycle performance of the silicon negative electrode lithium-ion battery. For example, the value of c may be 10, 12, 13, 15, 18, 20, 25, 28, 30, or falls within a range defined by any two of these values.

In some embodiments, the electrolyte includes a substance B. The substance B includes ethylene carbonate and/or propylene carbonate, and based on the mass of the electrolyte, a mass percentage of the substance B is d %, where 10≤d≤20. Preferably, 0.5≤c/d≤3. Further adding the substance B with a type and content within the above ranges to the electrolyte can effectively reduce side reactions of a battery during high-temperature cycling and reduce consumption of the electrolyte, thereby enhancing the high-temperature cycle performance of the silicon negative electrode lithium-ion battery. For example, the value of d may be 10, 11, 12, 13, 14, 15, 16, 17, 18, 19, 20, or falls within a range defined by any two of these values. For example, the value of c/d may be 0.5, 0.8, 1, 1.2, 1.5, 1.8, 2, 2.5, 2.8, 3, or falls within a range defined by any two of these values.

In some embodiments, the electrolyte includes a boron-containing lithium salt and a substance C, where the boron-containing lithium salt includes at least one of lithium tetrafluoroborate, lithium difluoro (oxalato) borate, or lithium bis(oxalato) borate, and the substance C includes vinylene carbonate and/or 1,3-propane sultone. Based on a total mass of the electrolyte, a mass percentage of the boron-containing lithium salt is 0.1% to 5%, and a mass percentage of the substance C is 0.5 wt % to 5 wt %. At this time, the boron-containing lithium salt, the substance C, and the compound represented by formula I can cooperate, promoting the formation of a suitable surface layer on the surface of the silicon-carbon particles, thereby improving the high-temperature and high-voltage performance of the silicon negative electrode lithium-ion battery.

Thickness of the negative electrode current collector is not particularly limited in this application, provided that the objectives of this application can be achieved. For example, the thickness of the negative electrode current collector is 5 μm to 12 μm. The negative electrode current collector is not particularly limited in this application, provided that the objectives of this application can be achieved. For example, the negative electrode current collector may include copper foil, copper alloy foil, nickel foil, stainless steel foil, titanium foil, nickel foam, copper foam, a composite current collector, or the like.

The negative electrode material layer may further include a binder and a thickener. The binder and the thickener are not particularly limited in this application, provided that the objectives of this application can be achieved. For example, the binder may include, but is not limited to, at least one of polyvinyl alcohol, polyvinyl chloride, carboxylated polyvinyl chloride, polyvinyl fluoride, polyvinylpyrrolidone, polyurethane, polytetrafluoroethylene, polyvinylidene fluoride, styrene-butadiene rubber, or acrylated styrene-butadiene rubber. The thickener may include, but is not limited to, at least one of sodium carboxymethyl cellulose or lithium carboxymethyl cellulose.

The negative electrode material layer may further include a conductive agent. A type of the conductive agent is not particularly limited in this application, provided that the objectives of this application can be achieved. For example, the conductive agent may include, but is not limited to, at least one of conductive carbon black, carbon nanotubes (CNTs), carbon fibers, Ketjen black, graphene, a metal material, or a conductive polymer. A mass ratio of the negative electrode active material, the conductive agent, the binder, and the thickener in a negative electrode active layer is not particularly limited in this application, and persons skilled in the art can make selection based on actual needs, provided that the objectives of this application can be achieved. Optionally, the negative electrode plate may further include a conductive layer, and the conductive layer is located between the negative electrode current collector and the negative electrode active layer. Composition of the conductive layer is not particularly limited in this application, and the conductive layer may be a conductive layer commonly used in the art. For example, the conductive layer includes a conductive agent and a binder. The conductive agent and the binder in the conductive layer are not particularly limited in this application, and may be, for example, at least one of the above conductive agent and the binder in the negative electrode active layer described above.

### Others

The lithium-ion secondary battery further includes a positive electrode plate, and the positive electrode plate includes a positive electrode current collector and a positive electrode active material layer disposed on a surface of the positive electrode current collector. The positive electrode current collector is not particularly limited in this application, provided that the objectives of this application can be achieved. For example, the positive electrode current collector may include aluminum foil, aluminum alloy foil, a composite current collector (for example, a composite current collector with a metal layer disposed on a surface of a polymer layer).

Thickness of the positive electrode current collector is not particularly limited in this application, provided that the objectives of this application can be achieved. For example, the thickness of the positive electrode current collector is 5 μm to 13 μm.

The positive electrode active material layer includes a positive electrode active material. The positive electrode active material is not particularly limited in this application, provided that the objectives of this application can be achieved. For example, the positive electrode active material may include a lithium composite metal oxide containing one or more of a group consisting of cobalt, manganese, and nickel, or a lithium-containing olivine-type phosphate containing one or more of iron, cobalt, nickel, and manganese. These positive electrode active substances may be used alone, or two or more of types may be used in combination.

As such lithium composite metal oxides, for example, one or more selected from LiCoO₂, LiMn₂O₄, LiNiO₂, LiCo₁₋ₓNiₓO₂ (0.01<x<1), LiNiₓMn_{y}Co₂O₂ (x+y+z=1), a solid solution of Li₂MnO₃ and LiMO₂ (where M is a transition metal such as Co, Ni, Mn, Fe), LiNi_{1/2}Mn_{3/2}O₄, LiFePO₄, LiMnPO₄, and LiMn₁₋ₓFeₓPO₄ (0.01<x<1) may be suitably listed, with more being more preferred. A portion of these lithium composite metal oxides or lithium-containing olivine-type phosphates may be substituted with other elements, or a portion of cobalt, nickel, manganese, or iron may be substituted with one or more elements selected from Co, Mn, Ni, Mg, Al, B, Ti, V, Nb, Cu, Zn, Mo, Ca, Sr, W, and Zr, or coated with a compound containing these other elements or a carbon material. Thickness of the positive electrode active material layer is not particularly limited, provided that the objective of this application can be achieved. For example, the thickness of the positive electrode active material layer is 30 μm to 120 μm.

The positive electrode active material layer may further include a conductive agent and a binder. Types of the conductive agent and the binder are not particularly limited in this application, provided that the objectives of this application can be achieved. For example, the conductive agent may include, but is not limited to, at least one of conductive carbon black, carbon nanotubes (CNTs), carbon fibers, Ketjen black, graphene, a metal material, or a conductive polymer. The binder may include, but is not limited to, at least one of polyacrylic acid, polyacrylate salt, an acrylate polymer, polyvinyl alcohol, polyvinylidene fluoride, polytetrafluoroethylene, or a vinylidene fluoride-hexafluoropropylene copolymer.

A mass ratio of the positive electrode active material, the conductive agent, and the binder in the positive electrode active material layer is not particularly limited in this application, and persons skilled in the art can make selection based on actual needs, provided that the objectives of this application can be achieved.

The lithium-ion secondary battery further includes a separator. The separator is configured to separate the positive electrode plate from the negative electrode plate to prevent short circuit inside the secondary battery and to allow electrolyte ions to pass through freely without affecting electrochemical charging and discharging processes. The separator is not particularly limited in this application, provided that the objectives of this application can be achieved. For example, material of the separator may include, but is not limited to, at least one of polyethylene (PE) and polypropylene (PP)-based polyolefin (PO), polyester (for example, a polyethylene terephthalate (PET) film), cellulose, polyimide (PI), polyamide (PA), spandex, or aramid. Type of the separator may include at least one of a woven film, a nonwoven film, a microporous film, a composite film, a laminated film, or a spinning film.

In this application, the separator may include a substrate and a surface treatment layer. The substrate may be a non-woven fabric or a composite film of a porous structure, and material of the substrate may include at least one of polyethylene, polypropylene, polyethylene terephthalate, or polyimide. Optionally, a polypropylene porous film, a polyethylene porous film, polypropylene non-woven fabric, a polyethylene non-woven fabric, or a polypropylene-polyethylene-polypropylene porous composite film may be used. Optionally, a surface treatment layer is disposed on at least one surface of the substrate, and the surface treatment layer may be a polymer layer or an inorganic layer, or a layer formed by a mixture of a polymer and an inorganic substance. For example, the inorganic layer includes inorganic particles and a binder. The inorganic particles are not particularly limited in this application. For example, the inorganic particles may include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is not particularly limited in this application. For example, the binder may be at least one of the binders mentioned above. The polymer layer contains a polymer, and material of the polymer includes at least one of polyamide, polyacrylonitrile, acrylate polymer, polyacrylic acid, polyvinylpyrrolidone, polyvinyl ether, polyvinylidene fluoride, or poly(vinylidene fluoride-hexafluoropropylene).

In this application, a pore size of the separator is 0.01 μm to 1 μm, and a thickness is 5 μm to 50 μm. In some embodiments, the thickness of the separator is greater than 1 μm, greater than 5 μm, or greater than 8 μm. In some embodiments, the thickness of the separator is less than 50 μm, less than 40 μm, or less than 30 μm. When the thickness of the separator falls within the above range, insulation and mechanical strength can be ensured, and the rate performance and energy density of the secondary battery can be ensured.

The electrochemical apparatus of this application further includes a packaging bag for accommodating the positive electrode plate, the separator, the negative electrode plate, and the electrolyte, and other components known in the art in the electrochemical apparatus. The other components are not limited in this application. The packaging bag is not particularly limited in this application and may be any well-known packaging bag in the art, provided that the objectives of this application can be achieved.

The lithium-ion secondary battery can be prepared according to conventional methods in the art. For example, the positive electrode plate, the separator, and the negative electrode plate described above are stacked in sequence, so that the separator is located between the positive electrode plate and the negative electrode plate for separation to obtain an electrode assembly, or the resulting stack is wound to obtain an electrode assembly; and the electrode assembly is placed in a packaging housing, the electrolyte is injected, and the housing is sealed, to obtain the secondary battery. A structure of the lithium-ion secondary battery is not particularly limited and can be applied to a coin-type battery, a cylindrical battery, a prismatic battery, or a pouch battery with a single-layer or multi-layer separator.

The lithium-ion battery of this application is not particularly limited to any purpose, and may be used in any electronic apparatus known in the prior art. In some embodiments, the lithium-ion battery of this application may be used without limitation in a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, or a lithium-ion capacitor.

The following describes some embodiments of this application more specifically by using examples and comparative examples. Unless otherwise stated, the parts, percentages, and ratios listed are based on mass.

### Example 1-1

### (I) Preparation of Lithium-Ion Battery

### <Preparation of Negative Electrode Plate>

Artificial graphite, silicon-carbon particles with a silicon content of 15%, conductive carbon black, and a binder polyacrylic acid (PAA) were mixed at a mass ratio of 70%:15%:5%:10%, an appropriate amount of water was added, and the mixture was kneaded at a solid content of approximately 55 wt % to 70 wt %. An appropriate amount of water was added to adjust a viscosity of a slurry to approximately 4000 Pa·s to 6000 Pa·s, and a negative electrode slurry is prepared. The negative electrode slurry was uniformly applied onto one surface of a negative electrode current collector copper foil with a thickness of 6 μm, and the copper foil was dried at 85° C. for 4 hours to obtain a negative electrode plate with one surface coated with a negative electrode mixture layer. Then, after cold pressing (cold pressing pressure of 20 t), cutting, and slitting, drying was performed in vacuum at 120° C. for 12 hours to obtain a negative electrode plate with a size of 76.6 mm×875 mm. A compacted density of the negative electrode material layer after cold pressing was 1.70 g/cm³.

### <Preparation of Positive Electrode Plate>

A positive electrode active material lithium cobalt oxide (LiCoO₂), a conductive agent Super P, and a binder polyvinylidene fluoride (PVDF) were mixed at a mass ratio of 97:1.4:1.6, N-methylpyrrolidone (NMP) was added as a solvent, a slurry with a solid content of 75 wt % was prepared, and the mixture was stirred uniformly in a vacuum mixer to obtain a positive electrode slurry. The positive electrode slurry was uniformly applied onto one surface of a positive electrode current collector aluminum foil with a thickness of 10 μm, and dried at 85° C. to obtain a positive electrode plate having a positive electrode material layer coated on one surface, with a coating thickness of 110 μm. Subsequently, the above steps were repeated on another surface of the aluminum foil to obtain a positive electrode plate coated with the positive electrode material layer on two surfaces. After coating was completed, the positive electrode plate was cold pressed and cut into a size of 74 mm×867 mm for later use. A compacted density of the positive electrode material layer after cold pressing was 4.15 g/cm³.

### <Preparation of Electrolyte>

In an argon atmosphere glove box having a water content of less than 10 ppm, dimethyl carbonate and ethyl methyl carbonate were used as base solvents, a lithium salt lithium hexafluorophosphate and a compound represented by formula I were added to the base solvents, and mixed uniformly to obtain an electrolyte. Based on a mass of the electrolyte, a mass percentage of the lithium salt lithium hexafluorophosphate was 12.5%, a mass percentage of the compound represented by formula I was as shown in Table 1, and the remainder was the base solvents, with a mass ratio of dimethyl carbonate to ethyl methyl carbonate of 1:1.

### <Separator>

A polyethylene (PE) porous film with a thickness of 5 μm was used.

### <Preparation of Lithium-Ion Battery>

The prepared positive electrode plate, separator, negative electrode plate, and separator were stacked in sequence, so that the separator was located between the positive electrode plate and the negative electrode plate for separation, and then a resulting stack was wound to obtain an electrode assembly. After tabs were welded, the electrode assembly was placed into an aluminum-plastic film packaging bag, dried in a vacuum oven at 85° C. for 12 hours to remove moisture. The prepared electrolyte was injected, followed by processes such as vacuum packaging, standing, formation (charged to 4.4 V at a constant current of 0.7 C, charged at a constant voltage to 0.025 C, left standing for 5 minutes, and discharged to 3.0 V at 0.5 C), shaping, and capacity testing, to obtain a lithium-ion battery.

### Example 1-2 to Example 1-21

These examples were the same as Example 1-1 except that the related preparation parameters were adjusted according to Table 1. For example, the thickness X of the surface layer in Table 1 can be achieved by adjusting the value of an average particle size Y of the silicon-carbon particles, that is, the smaller the value of Y, the smaller the corresponding thickness of the surface layer.

### Example 2-1 to Example 2-9

In a preparation process of the electrolyte in Example 1-1, substances shown in Table 2 were further added to the base solvents, with the remainder being the base solvents, and the rest was the same as Example 1-1.

### Example 3-1 to Example 3-6

In a preparation process of the electrolyte in Example 1-1, substances shown in Table 3 were further added to the base solvents, with the remainder being the base solvents, and the rest was the same as Example 1-1.

### Example 3-7

In a preparation process of the electrolyte in Example 2-7, substances shown in Table 3 were further added to the base solvents, with the remainder being the base solvents, and the rest was the same as Example 2-7.

### Comparative Example 1 to Comparative Example 5

These comparative examples were the same as Example 1-1 except that the related preparation parameters were adjusted according to Table 1.

### (II) Test Methods

### (1) Test for Parameters of Negative Electrode Plate

The lithium-ion batteries prepared in the above examples and comparative examples were disassembled to obtain negative electrode plates for subsequent testing and analysis.

A negative electrode material layer on the negative electrode plate was scraped off using a scraper, and the scraped powder of the negative electrode material layer was thermally treated in a tubular furnace at 400° C. for 4 hours under protection of argon for subsequent testing and analysis.

### Test for Thickness of Surface Layer and Average Particle Size of Silicon-Carbon Particles

Relevant parameters of the silicon-carbon particles were tested when the electrochemical apparatus was in a fully discharged state. Specifically, the lithium-ion batteries in the examples and comparative examples were disassembled according to the method described above to obtain negative electrode plates.

The negative electrode plate was cut into a size of 0.5 cm×1 cm, and the cut negative electrode plate was attached to a silicon wafer carrier with a size of 1 cm×1.5 cm using a conductive adhesive, and then a cross-section of the negative electrode plate along a thickness direction was subjected to argon ion polishing (parameters: an acceleration voltage of 8 KV, processing for 4 hours) for subsequent observation. In combination with a scanning electron microscope (SEM), a ZEISS SEM (Sigma-02-33) (0.1-30 KV) device was used in backscattered mode at a magnification of 100K to observe the cross-section of the processed negative electrode plate along the thickness direction to obtain an SEM image. In the SEM image, all silicon-carbon particles in a field of view were observed, and a longest distance between any two points on the silicon-carbon particles was taken as a particle size of the silicon-carbon particles to calculate an average particle size of the silicon-carbon particles. One silicon-carbon particle was optionally selected, and thicknesses of any 100 points on an edge of the surface layer of the silicon-carbon particles were measured to calculate an average value to obtain a thickness of the surface layer of the silicon-carbon particles.

### (2) High-Temperature Volume Expansion Test (at 80° C. At 4.53 V)

The lithium-ion battery was charged to 4.53 V at a constant current of 0.2 C, charged to 0.05 C at a constant voltage of 4.53 V, and left standing for 5 minutes. An initial thickness H0 of the lithium-ion battery was tested.

The lithium-ion battery was placed in a 80° C. thermostat, and left standing for 7 hours. A final thickness H′ of the lithium-ion battery was tested. Volume expansion rate=(H′−H0)/H0×100%.

### (3) High-Temperature Cycling Test (at 45° C. At 4.53 V)

The lithium-ion battery was placed in a constant temperature environment at 45° C. and left standing for 30 minutes, so that the lithium-ion battery reached a constant temperature state of 45° C. The battery was charged to 4.53 V at a constant current of 1 C, charged at a constant voltage of 4.53 V until a current reached 0.025 C, left standing for 5 minutes, and discharged to 3.0 V at a constant current of 0.5 C. An initial discharge capacity was recorded as C0, and an initial impedance was recorded as I0. The above charge-discharge steps were repeated for 500 cycles, and a discharge capacity after 500 cycles was recorded as C1, with an impedance of I1.

$$Cycle capacity retention rate = C 1 / C 0 \times 100 \% . Impedance growth rate = I 1 / I 0 \times 100 \% .$$

TABLE 1

| | | | | | | | | | Cycle | |
|---|---|---|---|---|---|---|---|---|---|---|
| | Compound | | | | | | | | capacity | |
| | represented by | | | | Average | | | Volume | retention rate | |
| | formula I | | Thickness of | | particle size of | | | expansion | after 500 | Cycle impedance |
| | | Content | surface layer | | silicon-carbon | | | at 80° C. at | cycles at 45° C. | growth rate at |
| | Type | a/% | X/μm | X/a | particle Y/μm | X/Y | Y/a | 4.53 V | at 4.53 V | 45° C. at 4.53 V |
| Comparative | Formula | 5 | 4 | 0.8 | 0.3 | 13.33 | 0.06 | 15.3% | 72.4% | 90.3% |
| Example 1 | I-1 | | | | | | | | | |
| Comparative | Formula | 0.5 | 6 | 12 | 0.3 | 20 | 0.6 | 16.1% | 71.4% | 92.3% |
| Example 2 | I-1 | | | | | | | | | |
| Comparative | Formula | 0.3 | 2.4 | 8 | 0.3 | 8 | 1 | 23.2% | 69.4% | 99.1% |
| Example 3 | I-1 | | | | | | | | | |
| Comparative | Formula | 25 | 30 | 1.2 | 0.3 | 100 | 0.012 | 21.8% | 70.1% | 97.4% |
| Example 4 | I-1 | | | | | | | | | |
| Comparative | / | / | 6 | / | 0.3 | 20 | / | 28.5% | 64.3% | 99.5% |
| Example 5 | | | | | | | | | | |
| Example 1-1 | Formula | 12 | 15 | 1.25 | 0.9 | 16.67 | 0.075 | 12.3% | 75.8% | 85.2% |
| | I-1 | | | | | | | | | |
| Example 1-2 | Formula | 0.5 | 4 | 8 | 0.1 | 40 | 0.2 | 10.0% | 79.3% | 87.2% |
| | I-1 | | | | | | | | | |
| Example 1-3 | Formula | 2 | 6 | 3 | 0.3 | 20 | 0.15 | 8.1% | 87.3% | 69.7% |
| | I-1 | | | | | | | | | |
| Example 1-4 | Formula | 5 | 8 | 1.6 | 0.4 | 20 | 0.08 | 9.6% | 83.4% | 85.3% |
| | I-1 | | | | | | | | | |
| Example 1-5 | Formula | 8 | 10 | 1.25 | 0.6 | 16.67 | 0.075 | 9.3% | 85.6% | 84.9% |
| | I-1 | | | | | | | | | |
| Example 1-6 | Formula | 0.5 | 6 | 3 | 0.3 | 20 | 0.6 | 10.5% | 80.1% | 87.1% |
| | I-1 | | | | | | | | | |
| Example 1-7 | Formula | 1 | 6 | 3 | 0.3 | 20 | 0.3 | 9.8% | 84.4% | 83.1% |
| | I-1 | | | | | | | | | |
| Example 1-8 | Formula | 5 | 6 | 3 | 0.3 | 20 | 0.06 | 8.3% | 87.1% | 71.5% |
| | I-1 | | | | | | | | | |
| Example 1-9 | Formula | 8 | 6 | 3 | 0.3 | 20 | 0.04 | 8.5% | 87.3% | 73.8% |
| | I-1 | | | | | | | | | |
| Example 1-10 | Formula | 12 | 6 | 3 | 0.3 | 20 | 0.025 | 8.9% | 84.7% | 82.1% |
| | I-1 | | | | | | | | | |
| Example 1-11 | Formula | 15 | 6 | 3 | 0.3 | 20 | 0.02 | 9.3% | 85.7% | 85.1% |
| | I-1 | | | | | | | | | |
| Example 1-12 | Formula | 20 | 6 | 3 | 0.3 | 20 | 0.015 | 9.7% | 82.8% | 86.6% |
| | I-1 | | | | | | | | | |
| Example 1-13 | Formula | 2 | 6 | 1.2 | 0.3 | 20 | 0.15 | 8.2% | 86.9% | 70.1% |
| | I-1 | | | | | | | | | |
| Example 1-14 | Formula | 2 | 6 | 2 | 0.3 | 20 | 0.15 | 8.3% | 87.1% | 69.9% |
| | I-1 | | | | | | | | | |
| Example 1-15 | Formula | 2 | 6 | 4 | 0.3 | 20 | 0.15 | 8.2% | 87.1% | 70.3% |
| | I-1 | | | | | | | | | |
| Example 1-16 | Formula | 2 | 6 | 6 | 0.3 | 20 | 0.15 | 8.3% | 86.9% | 71.1% |
| | I-1 | | | | | | | | | |
| Example 1-17 | Formula | 2 | 6 | 8 | 0.3 | 20 | 0.15 | 8.3% | 86.9% | 71.5% |
| | I-1 | | | | | | | | | |
| Example 1-18 | Formula | 2 | 6 | 9.8 | 0.3 | 20 | 0.15 | 8.5% | 86.3% | 72% |
| | I-1 | | | | | | | | | |
| Example 1-19 | Formula | 5 | 8 | 1.6 | 0.4 | 20 | 0.08 | 8.8% | 81.9% | 86.2% |
| | I-8 | | | | | | | | | |
| Example 1-20 | Formula | 5 | 8 | 1.6 | 0.4 | 20 | 0.08 | 8.5% | 82.6% | 87.0% |
| | I-14 | | | | | | | | | |
| Example 1-21 | Formula | 5 | 8 | 1.6 | 0.4 | 20 | 0.08 | 8.9% | 81.7% | 86.3% |
| | I-20 | | | | | | | | | |

Note:
“/” in the table indicates no relevant parameter.

Referring to Table 1, for Comparative Example 1 to Comparative Example 5, compared with Example 1-1, in Comparative Example 1 to Comparative Example 2, a ratio (X/a) of the thickness X of the surface layer of silicon-carbon particles to a content a of the compound represented by formula I in the electrolyte is not within a suitable range. In Comparative Example 3 to Comparative Example 4, the content a of the compound represented by formula I in the electrolyte is not within a suitable range. In Comparative Example 5, the electrolyte does not contain the compound represented by formula I. As shown in Table 1, the high-temperature performance of silicon negative electrode lithium-ion batteries corresponding to Comparative Example 1 to Comparative Example 5 is significantly inferior to the high-temperature performance of Example 1-1. In particular, volume expansion rates of the silicon negative electrode lithium-ion batteries of Comparative Example 1 to Comparative Example 5 under conditions of 80° C. and 4.53 V are all above 15.3%, with the highest reaching 28.5%, and cycle impedance growth rates under conditions of 45° C. and 4.53 V are all above 90.3%, resulting in a maximum capacity retention rate under conditions of 45° C. and 4.53 V after 500 cycles of only 72.4%. In contrast, the silicon negative electrode lithium-ion battery of Example 1-1 has a volume expansion rate of only 12.3% under conditions of 80° C. and 4.53 V, a cycle impedance growth rate significantly reduced to 85.2%, and a capacity retention rate after 500 cycles under the same conditions increased to 75.8%.

In particular, when the content a of a compound represented by formula I and the thickness X of the surface layer of the silicon-carbon particles are further regulated to be within preferred ranges, and the particle size of the silicon-carbon particles is cooperatively regulated to be within a suitable range, an effect of improving the volume expansion and impedance growth of the silicon negative electrode lithium-ion battery under high-temperature and high-voltage conditions is better, which facilitates further enhancing the cycle performance of the silicon negative electrode lithium-ion battery at high-temperature.

TABLE 2

| | Content b of | | | | | | Substance B | | | Cycle capacity retention |
|---|---|---|---|---|---|---|---|---|---|---|
| | fluoroethylene | Substance A | | | | c | | Content | | rate after 500 cycles at |
| | carbonate | Type | Content/% | Type | Content/% | value | Type | d/% | c/d | 45° C. at 4.53 V (%) |
| Example | / | / | / | / | / | / | / | / | / | 75.8 |
| 1-1 | | | | | | | | | | |
| Example | 12 | / | / | / | / | / | / | / | / | 77.5 |
| 2-1 | | | | | | | | | | |
| Example | 20 | / | / | / | / | / | / | / | / | 77.8 |
| 2-2 | | | | | | | | | | |
| Example | 22 | / | / | / | / | / | / | / | / | 77.3 |
| 2-3 | | | | | | | | | | |
| Example | 20 | Diethyl | 25 | Propyl | 5 | 30 | / | / | / | 82.1 |
| 2-4 | | carbonate | | propionate | | | | | | |
| Example | 20 | Diethyl | 3 | Propyl | 3 | 6 | / | / | / | 75.4 |
| 2-5 | | carbonate | | propionate | | | | | | |
| Example | 20 | Diethyl | 5 | Propyl | 5 | 10 | / | / | / | 82.9 |
| 2-6 | | carbonate | | propionate | | | | | | |
| Example | 20 | Diethyl | 10 | Propyl | 10 | 20 | Propylene | 20 | 1 | 87.1 |
| 2-7 | | carbonate | | propionate | | | carbonate | | | |
| Example | 20 | Diethyl | 15 | Ethyl | 15 | 30 | Ethylene | 10 | 3 | 86.7 |
| 2-8 | | carbonate | | propionate | | | carbonate | | | |
| Example | 20 | Propyl | 10 | Ethyl | 10 | 20 | Propylene | 20 | 1 | 76.1 |
| 2-9 | | propionate | | propionate | | | carbonate | | | |

Referring to Table 2, it can be learned that when an appropriate amount of fluoroethylene carbonate is further added to the electrolyte of Example 1-1, the cycle performance of the silicon negative electrode lithium-ion battery under high-temperature conditions can be further improved, particularly enhancing the capacity retention rate after 500 cycles at 45° C. at 4.53 V. Moreover, when an appropriate amount of a substance A and a substance B are further added, and types of the substance A and the substance B are within the above ranges, an effect of improving the cycle performance of the silicon negative electrode lithium-ion battery under high-temperature conditions is better.

TABLE 3

| | | | | | | Cycle | |
|---|---|---|---|---|---|---|---|
| | | | | | | capacity | |
| | | | | | | retention | Cycle |
| | | | | | | rate | impedance |
| | | | | | Volume | after 500 | growth |
| | | | | | expansion | cycles at | rate at |
| | Boron-containing lithium salt | | Substance C | | at 80° C. | 45° C. at | 45° C. at |
| | Type | Content/% | Type | Content/% | at 4.53 V | 4.53 V | 4.53 V |
| Example | Lithium tetrafluoroborate | 1 | Vinylene carbonate | 3 | 10.1% | 83.9% | 74.9% |
| 3-1 | | | | | | | |
| Example | Lithium tetrafluoroborate | 1 | 1,3-propane sultone | 3 | 9.7% | 84.1% | 75.3% |
| 3-2 | | | | | | | |
| Example | Lithium tetrafluoroborate | 1 | Vinylene carbonate + | 1.5 + 1.5 | 8.8% | 85.7% | 72.4% |
| 3-3 | | | 1,3-propane sultone | | | | |
| Example | Lithium tetrafluoroborate + | 0.5 + 0.5 | Vinylene carbonate + | 1.5 + 1.5 | 8.3% | 86.9% | 70.3% |
| 3-4 | Lithium bis(oxalato)borate | | 1,3-propane sultone | | | | |
| Example | Lithium bis(oxalato)borate | 1 | Vinylene carbonate + | 1.5 + 1.5 | 10.9% | 78.6% | 86.9% |
| 3-5 | | | 1,3-propane sultone | | | | |
| Example | Lithium | 1 | Vinylene carbonate + | 1.5 + 1.5 | 10.7% | 78.4% | 87.5% |
| 3-6 | difluoro(oxalato)borate | | 1,3-propane sultone | | | | |
| Example | Lithium tetrafluoroborate | 1 | Vinylene carbonate + | 1.5 + 1.5 | 8.5% | 88.5% | 71.6% |
| 3-7 | | | 1,3-propane sultone | | | | |

Referring to Table 3, it can be learned that an appropriate amount of the boron-containing lithium salt and the substance C are added to the electrolyte of Example 1-1, with appropriate types of the boron-containing lithium salt and the substance C, the high-temperature and high-voltage performance of the silicon negative electrode lithium-ion battery can also be improved. In particular, when the boron-containing lithium salt and the substance C with the above types and contents are further added to the electrolyte of Example 2-7, an effect of improving the high-temperature and high-voltage performance of the silicon negative electrode lithium-ion battery is optimal.

The above descriptions are merely preferred embodiments of this application, but are not intended to limit this application. Any modification, equivalent replacement, or improvement made without departing from the spirit and principle of this application shall fall within the protection scope of this application.

What is claimed is:

1. An electrochemical apparatus, wherein the electrochemical apparatus comprises a negative electrode plate and an electrolyte;
the negative electrode plate comprises a negative electrode material layer, the negative electrode material layer containing silicon-carbon particles, a surface of the silicon-carbon particles having a surface layer, and a thickness of the surface layer being X μm;
the electrolyte comprises a compound represented by formula I: 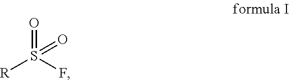
wherein R is selected from a fluorine-substituted or unsubstituted C₂-C₆ alkyl, a fluorine-substituted or unsubstituted C₆-C₁₂ nitrogen-containing heterocyclic group, or a fluorine-substituted or unsubstituted C₆-C₁₂ aryl group; and
based on a mass of the electrolyte, a mass percentage of the compound represented by formula I is a %, 0.5≤a≤20, and 1<X/a<10.

2. The electrochemical apparatus according to claim 1, wherein the compound represented by formula I comprises at least one of the following compounds:

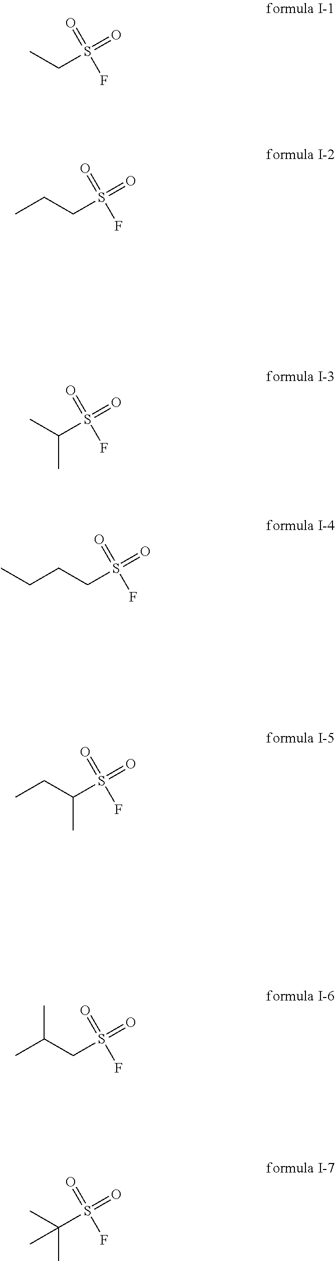

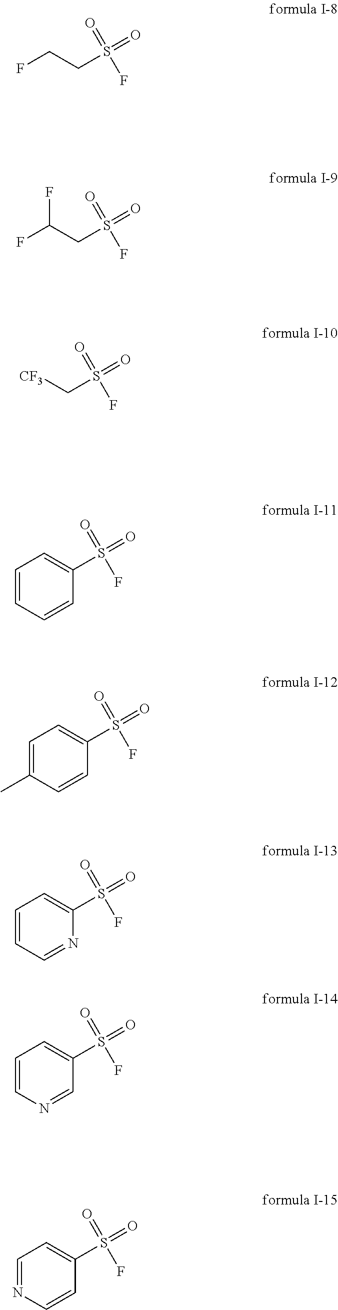

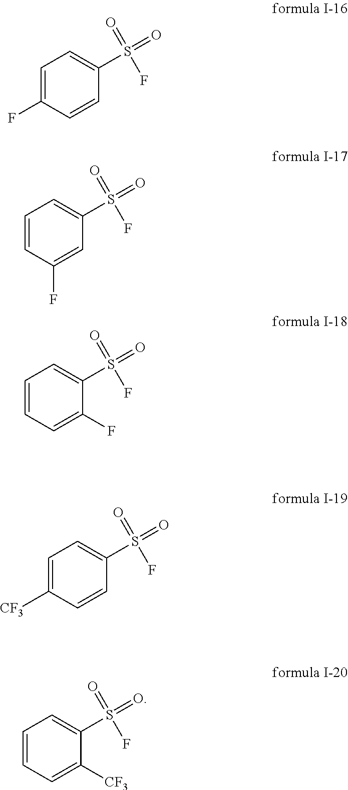 [SMILES: O=S(=O)(F)c1ccc(F)cc1 ; O=S(=O)(F)c1cccc(F)c1 ; O=S(=O)(F)c1ccccc1F ; O=S(=O)(F)c1ccc(C(F)(F)F)cc1 ; O=S(=O)(F)c1ccccc1C(F)(F)F]

3. The electrochemical apparatus according to claim 1, wherein the electrochemical apparatus satisfies at least one of the following conditions:
$$2 \leq a \leq 10 ; \qquad ( 1 )$$
$$5 < X < 12. \qquad ( 2 )$$

4. The electrochemical apparatus according to claim 1, wherein an average particle size of the silicon-carbon particles is Y μm, and 0.1≤Y<1.

5. The electrochemical apparatus according to claim 2, wherein an average particle size of the silicon-carbon particles is Y μm, and 0.1≤Y<1.

6. The electrochemical apparatus according to claim 3, wherein an average particle size of the silicon-carbon particles is Y μm, and 0.1≤Y<1.

7. The electrochemical apparatus according to claim 1, wherein the electrolyte includes fluoroethylene carbonate; and
based on the mass of the electrolyte, a mass percentage of the fluoroethylene carbonate is b %, and 12≤b≤22.

8. The electrochemical apparatus according to claim 2, wherein the electrolyte includes fluoroethylene carbonate; and
based on the mass of the electrolyte, a mass percentage of the fluoroethylene carbonate is b %, and 12≤b≤22.

9. The electrochemical apparatus according to claim 3, wherein the electrolyte includes fluoroethylene carbonate; and
based on the mass of the electrolyte, a mass percentage of the fluoroethylene carbonate is b %, and 12≤b≤22.

10. The electrochemical apparatus according to claim 7, wherein the electrolyte includes a substance A, the substance A comprising diethyl carbonate, and at least one of propyl propionate or ethyl propionate; and
based on the mass of the electrolyte, a mass percentage of the substance A is c %, and 10≤c≤30.

11. The electrochemical apparatus according to claim 10, wherein the electrolyte further includes a substance B, the substance B comprising ethylene carbonate and/or propylene carbonate; and
based on the mass of the electrolyte, a mass percentage of the substance B is d %, and 10≤d≤20.

12. The electrochemical apparatus according to claim 11, wherein 0.5≤c/d≤3.

13. The electrochemical apparatus according to claim 1, wherein the electrolyte includes a boron-containing lithium salt and a substance C;
the boron-containing lithium salt comprises at least one of lithium tetrafluoroborate, lithium difluoro (oxalato) borate, or lithium bis(oxalato) borate, and the substance C comprises vinylene carbonate and/or 1,3-propane sultone; and
based on a total mass of the electrolyte, a mass percentage of the boron-containing lithium salt is 0.1% to 5%, and a mass percentage of the substance C is 0.5 wt % to 5 wt %.

14. The electrochemical apparatus according to claim 2, wherein the electrolyte includes a boron-containing lithium salt and a substance C;
the boron-containing lithium salt comprises at least one of lithium tetrafluoroborate, lithium difluoro (oxalato) borate, or lithium bis(oxalato) borate, and the substance C comprises vinylene carbonate and/or 1,3-propane sultone; and
based on a total mass of the electrolyte, a mass percentage of the boron-containing lithium salt is 0.1% to 5%, and a mass percentage of the substance C is 0.5 wt % to 5 wt %.

15. The electrochemical apparatus according to claim 3, wherein the electrolyte includes a boron-containing lithium salt and a substance C;
the boron-containing lithium salt comprises at least one of lithium tetrafluoroborate, lithium difluoro (oxalato) borate, or lithium bis(oxalato) borate; the substance C comprises vinylene carbonate and/or 1,3-propane sultone; and
based on a total mass of the electrolyte, a mass percentage of the boron-containing lithium salt is 0.1% to 5%, and a mass percentage of the substance C is 0.5 wt % to 5 wt %.

16. An electronic device, comprising an electrochemical apparatus, wherein the electrochemical apparatus comprises a negative electrode plate and an electrolyte;
the negative electrode plate comprises a negative electrode material layer, the negative electrode material layer containing silicon-carbon particles, a surface of the silicon-carbon particles having a surface layer, and a thickness of the surface layer being X μm;
the electrolyte comprises a compound represented by formula I: 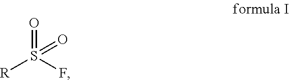
wherein R is selected from a fluorine-substituted or unsubstituted C₂-C₆ alkyl, a fluorine-substituted or unsubstituted C₆-C₁₂ nitrogen-containing heterocyclic group, or a fluorine-substituted or unsubstituted C₆-C₁₂ aryl group; and
based on a mass of the electrolyte, a mass percentage of the compound represented by formula I is a %, 0.5≤a≤20, and 1<X/a<10.

17. The electronic apparatus according to claim 16, wherein the compound represented by formula I comprises at least one of the following compounds:

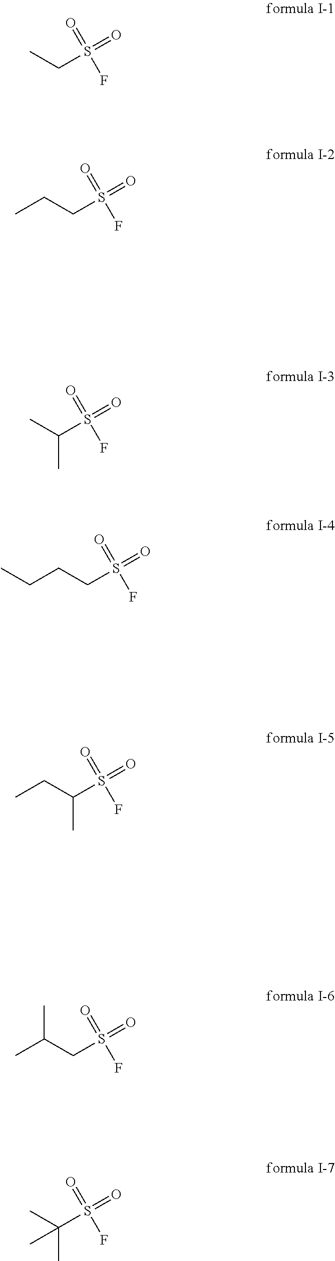

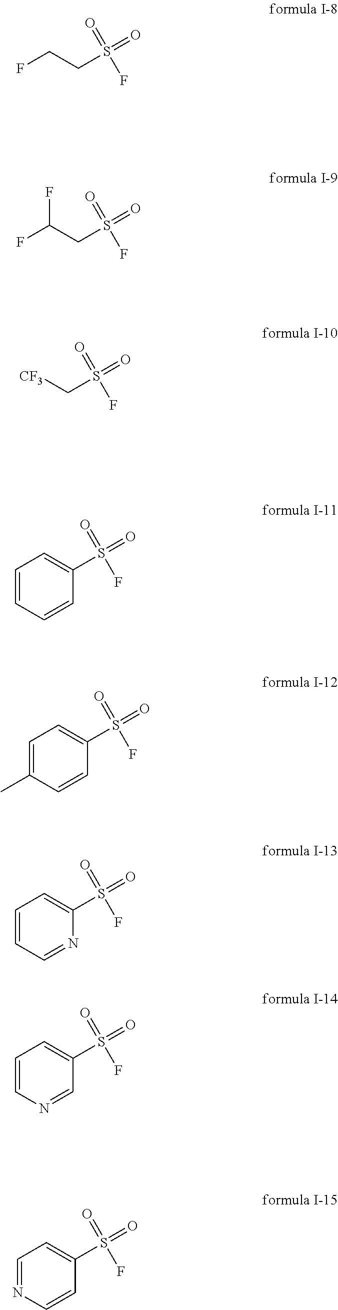

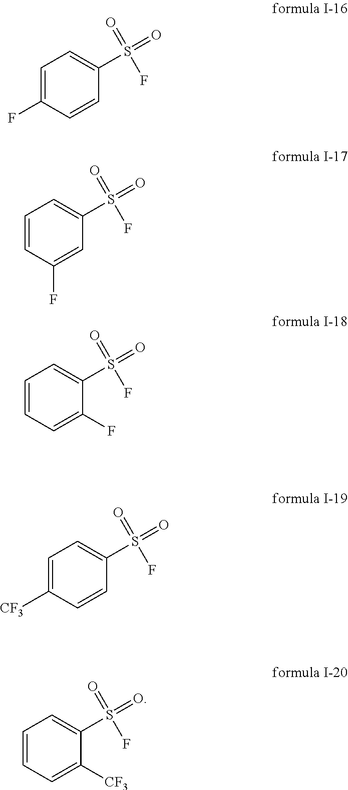 [SMILES: O=S(=O)(F)c1ccc(F)cc1 ; O=S(=O)(F)c1cccc(F)c1 ; O=S(=O)(F)c1ccccc1F ; O=S(=O)(F)c1ccc(C(F)(F)F)cc1 ; O=S(=O)(F)c1ccccc1C(F)(F)F]

18. The electronic apparatus according to claim 16, wherein the electrochemical apparatus satisfies at least one of the following conditions:
$$2 \leq a \leq 10 ; \qquad ( 1 )$$
$$5 < X < 12. \qquad ( 2 )$$

19. The electronic apparatus according to claim 16, wherein an average particle size of the silicon-carbon particles is Y μm, and 0.1≤Y<1.

20. The electronic apparatus according to claim 16, wherein the electrolyte includes fluoroethylene carbonate; and
based on the mass of the electrolyte, a mass percentage of the fluoroethylene carbonate is b %, and 12≤b≤22.
